(19) United States
(12) Patent Application Publication
(10) Pub. No.: US 2025/0049126 A1
(43) Pub. Date: Feb. 13, 2025

(54) APPARATUS FOR HEATING AEROSOL-GENERATING MATERIAL

(71) Applicant: NICOVENTURES TRADING LIMITED, London (GB)

(72) Inventors: Juan Esteban Pas JAUREGUI, London (GB); Ieuan CARNEY, London (GB); Nicholas ROSSER, London (GB); Benjamin TAYLOR, London (GB)

(21) Appl. No.: 18/721,271

(22) PCT Filed: Dec. 20, 2022
(86) PCT No.: PCT/EP2022/086961

§ 371 Date: Jun. 18, 2024

(30) Foreign Application Priority Data
Dec. 20, 2021 (GB) 2118554.1

(51) Int. Cl. A24F 40/46; A24D 1/20; A24F 40/20; H05B 6/10

(52) U.S. Cl. CPC A24F 40/46; A24D 1/20; A24F 40/20; H05B 6/108

(57) ABSTRACT

An aerosol provision device that includes a first wall defining a receiving section, a second wall surrounding the first wall. The device is configured to heat the receiving section, and wherein at least one of the first wall and second wall is configured to reflect and/or absorb thermal energy.

### RELATED APPLICATIONS

The present application is a National Phase entry of PCT Application No. PCT/EP2022/086961 filed Dec. 20, 2022, which claims priority to GB Application No. 2118554.1 filed Dec. 20, 2021, each of which is hereby incorporated by reference in their entirety.

### TECHNICAL FIELD

The present invention relates to an apparatus arranged to heat aerosol-generating material.

### BACKGROUND

Aerosol-provision systems generate aerosol an inhalable aerosol or vapor during use by releasing compounds from an aerosol-generating-material. These may be referred to as non-combustible smoking articles, aerosol generating assemblies, or aerosol provision devices, for example.

### SUMMARY

In accordance with some embodiments described herein, there is provided an aerosol provision device comprising a first wall defining a receiving section, a second wall surrounding the first wall. The device is configured to heat the receiving section, and wherein at least one of the first wall and second wall is configured to reflect and/or absorb thermal energy.

Optionally, the at least one of the first wall and second wall may have a coating applied thereto. The coating may be one of a reflective coating or an absorptive coating. The reflective coating may have an emissivity of at most 0.15 and the absorptive coating may have an emissivity of at least 0.90. The first wall may have the absorptive coating. The second wall may have the reflective coating configured to reflect heat towards the first wall.

Optionally, the reflective coating and/or absorptive coating may include at least one of a calcium silicate, EP30 insulating resin, an aerogel spray, a ceramic spray, an ultra-black paint coating, a white paint coating, a vanta-black paint coating and/or a phase change sheet/coating.

The first wall may be a wall of a susceptor. The second wall may be a wall of an insulating member.

In accordance with some embodiments described herein, there is provided an article for use in the aerosol provision device as described above. The article comprises a support comprising a surface comprising at least one portion configured to absorb and/or reflect thermal energy, and aerosol-generating material provided on the at least one portion.

Optionally, the at least one portion may include a coating. The coating may be one of a reflective coating or an absorptive coating. The reflective coating may have an emissivity of at most 0.15 and the absorptive coating may have an emissivity of at least 0.90. The first wall may have the absorptive coating.

Optionally, the reflective coating and/or absorptive coating may include at least one of a calcium silicate, EP30 insulating resin, an aerogel spray, a ceramic spray, an ultra-black paint coating, a white paint coating, a vanta-black paint coating and/or a phase change sheet/coating.

In accordance with some embodiments described herein, there is provided an aerosol provision device comprising a base and a lid connected to the base such that the lid can pivot around a hinge. The lid is configured to absorb and/or reflect thermal energy.

Optionally, the base may be configured to receive aerosol-generating material. The base may be configured to heat the aerosol-generating material. The lid may include a coating.

Optionally, the coating may be one of a reflective coating or an absorptive coating. The reflective coating may have an emissivity of at most 0.15 and the absorptive coating may have an emissivity of at least 0.90. The first wall may have the absorptive coating.

Optionally, the reflective coating and/or absorptive coating may include at least one of a calcium silicate, EP30 insulating resin, an aerogel spray, a ceramic spray, an ultra-black paint coating, a white paint coating, a vanta-black paint coating and/or a phase change sheet/coating.

### BRIEF DESCRIPTION OF THE DRAWINGS

Embodiments of the invention will now be described, by way of example only, with reference to accompanying drawings, in which:

FIG. 1 shows a cross-section of a portion of an apparatus for heating aerosol-generating material.

FIG. 2 shows a cross-section of another view of the portion of the apparatus for heating aerosol-generating material.

FIG. 3 shows a top-down view of an article that may be used in an apparatus for heating aerosol-generating material.

FIG. 4 shows a cross-section of an apparatus for heating aerosol-generating material.

### DETAILED DESCRIPTION

Apparatus is known that heats aerosol-generating material to volatilize at least one component of the aerosol-generating material, typically to form an aerosol which can be inhaled, without burning or combusting the aerosol-generating material. Such apparatus is sometimes described as a “heat-not-burn” apparatus or a “tobacco heating product” or “tobacco heating device” or similar. Similarly, there are also so-called e-cigarette devices, which typically vaporize an aerosol-generating material in the form of a liquid, which may or may not contain nicotine. In general, the aerosol-generating material may be in the form of or provided as part of a rod, cartridge or cassette or the like which can be inserted into the apparatus. A heating material for heating and volatilizing the aerosol-generating material may be provided as a “permanent” part of the apparatus or may be provided as part of the consumable article which is discarded and replaced after use. A “consumable article” in this context is a device or article or other component that includes or contains in use the aerosol-generating material, which in use is heated to volatilize the aerosol-generating material.

As used herein, the term “aerosol-generating material” includes materials that provide volatilized components upon heating, typically in the form of vapor or an aerosol. “Aerosol-generating material” may be a non-tobacco-containing material or a tobacco-containing material. “Aerosol-generating material” may, for example, include one or more of tobacco per se, tobacco derivatives, expanded tobacco, reconstituted tobacco, tobacco extract, homogenised tobacco or tobacco substitutes. The aerosol-generating material can be in the form of ground tobacco, cut rag tobacco, extruded tobacco, reconstituted tobacco, reconstituted aerosol-generating material, liquid, gel, gelled sheet, powder, or agglomerates, or the like. “Aerosol-generating material” also may include other, non-tobacco products, which, depending on the product, may or may not contain nicotine. “Aerosol-generating material” may comprise one or more humectants, such as glycerol or propylene glycol.

The aerosol-generating material may comprise or be an “amorphous solid”. In some embodiments, the aerosol-generating material comprises an aerosol-generating film that is an amorphous solid.

The amorphous solid may be a “monolithic solid”. The amorphous solid may be substantially non-fibrous. In some embodiments, the amorphous solid may be a dried gel. The amorphous solid is a solid material that may retain some fluid, such as liquid, within it. In some embodiments, the amorphous solid may, for example, comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

Whilst the examples herein are shown with a circular cross section, and may be described with reference to “circumferential” walls, it would be appreciated that these could have any cross section, and the teachings herein are equally applicable to any shaped device and their respective perimeters. For example, the walls may instead have a square cross section, or equally any other regular, or irregular shape.

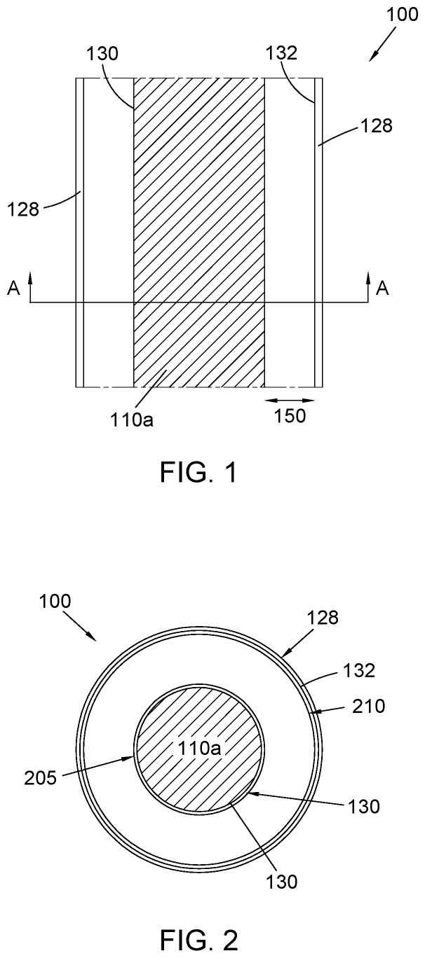

FIG. 1 shows a cross section of an example of an apparatus for heating an aerosolizable material, shown generally as 100. The apparatus 100 may include a receiving section 110a for receiving a consumable article (not shown), a first circumferential wall 130 that defines the receiving section 110a, a second circumferential wall 132 that surrounds the first circumferential wall 130. As shown in FIG. 1, the first circumferential wall 130 is spaced apart from the second circumferential wall 132 by a space defined by 150. In examples, the first circumferential wall 130 may be defined as a circumferential wall of an oven configured to heat a consumable article placed within. For example, the space defined by 150 allows for convection between the first circumferential wall 130 and the second circumferential wall 132.

As would be appreciated, an oven could be heated by any suitable means. For example, a heating element could wrap around the oven, and/or form an integral part of the oven, and/or be placed within the oven. Additionally or alternatively, the oven itself may be configured to generate heat, for example, the oven itself could function as a susceptor, for example to generate heat by inducing current in the presence of a magnetic field.

Surrounding, or forming, the second circumferential wall 132 may be an insulating member 128. For example, the insulating member 128 may include an inner circumferential wall that forms the second circumferential wall. The insulating member 128 may be, for example, a material that has relatively low thermal conductivity. For example, the insulating member 128 may have a conductivity of less than 0.1 W/mK.

FIG. 2 shows a cross-section of the apparatus 100 viewed along line A-A of FIG. 1. As can be seen in FIG. 2, the receiving section 110a is defined within the space provided by the first circumferential wall 130. As mentioned above, the receiving section 110a is sized and shaped for receiving a consumable article (not shown). Applied to the first circumferential wall may be a first coating 205. The first coating 205 may be applied to the outer surface of the first wall. In some examples, the first coating 205 may be an absorptive coating to absorb emitted heat during operation of the apparatus. For example, when the first circumferential wall 130 is defined as an oven (or susceptor), the heat emitted from the oven may be emitted radially outwards away from the receiving section 110a (for example, as waste heat). The absorptive coating acting as the first coating 205 may absorb the heat. Of course, it is understood that the apparatus 100 may be used with inductive heating as well where heat is provided from outside the second circumferential wall 132 in the direction towards the first circumferential wall 130 such that heat is provided to the receiving section 110a.

In a further example, the second circumferential wall 132 may be applied with a second coating 210. The second coating may be applied to the inner surface of the second wall. In some examples, the second coating 210 may be a reflective coating to reflect emitted heat during operation of the apparatus. For example, when the first circumferential wall 130 is defined as an oven, the heat emitted from the oven may be emitted radially outwards away from the receiving section 110a. The reflective coating acting as the second coating 210 may then reflect emitted heat back towards the receiving section 110a (i.e., towards a consumable during use).

It is envisaged that the apparatus 100 may include a first coating 205 and/or a second coating 210. The first coating 205 and/or the second coating 210 may be provided on either, or both, the first circumferential wall 130 and the second circumferential wall 132. Further, the first coating 205 and/or the second coating 210 may be absorptive. Alternatively, the first coating 205 and/or the second coating may be reflective.

In some examples, the first and/or second coating 205, 210 may include one of a calcium silicate, EP30 insulating resin, aerogel sprays (for example, microspheres of aerogel), ceramic sprays (for example, microbeads of ceramic material), ultra-black paint coatings, white paint coatings, vanta-black paint coatings and/or phase change sheets/coating (for example, sheets/coatings that use microbeads of wax/silica/silicone that change state to absorb thermal energy).

The first coating 205 and/or the second coating 210 may be provided fully to the surfaces of the first circumferential wall 130 and/or the second circumferential wall 132, or may be applied in part on the first circumferential wall 130 and/or the second circumferential wall 132. For example, a pattern of coating may be applied as the first and/or second coatings 205, 210.

‘Reflective coating’ means that the coating has an emissivity of 0.15 or less (i.e. 15% of energy from radiation received by the coating at a 90 degree angle is absorbed and the rest is reflected). Of course, the emissivity for the ‘reflective coating’ may be in the range of 0.10 to 0.20, or 0.05 to 0.25. ‘Absorptive coating’ means that the coating has an emissivity of 0.90 or greater (i.e. 90% of energy from radiation received by the coating at a 90 degree angle is absorbed and the rest is reflected). Of course, the emissivity for the ‘absorptive coating’ may be in the range of 0.85 to 0.95, or 0.80 to 0.95.

It is appreciated that the first circumferential wall 130 and/or the second circumferential wall 132 may have no coatings provided thereon and may, on the other hand, be made from a highly polished material or a matt material for providing reflective and/or absorptive properties.

The above described apparatus 100 ensures that any waste heat emitted from a heating element in the apparatus is redirected and/or stored for use in heating the consumable material (not shown). Therefore, any heat emitted within the apparatus is either reflected back to the consumable or absorbed close to the consumable to ensure maximum efficiency of the heat during use. This effect is particularly advantageous when an absorptive coating on the oven is provided with a reflective coating external to it, as it ensures that the heat generated by the device is retained by the oven, and thereby may be used to heat a consumable article received within the receiving section.

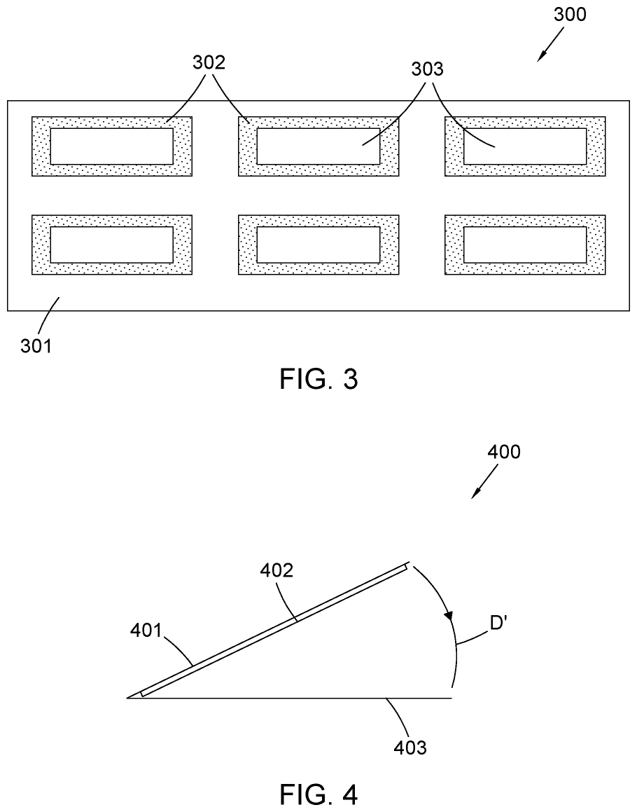

FIG. 3 shows an example of an article 300 that could be used in an apparatus for heating an aerosol-generating material. For example, the article 300 could be used in the apparatus 100 described above, where the article 300 is configured to be inserted into the receiving section 110a.

The article 300 may be cylindrical in shape or may be a planar shape. The article 300 may include at least one portion 302 configured to absorb and/or reflect thermal energy. An aerosol-generating material 303 may be provided on the at least one portion 302 configured to absorb and/or reflect thermal energy.

In an example, the at least one portion 302 may be provided with a coating. The coating may be a reflective coating or an absorptive coating. ‘Reflective coating’ means that the coating has an emissivity of 0.15 or less (i.e. 15% of energy from radiation received by the coating at a 90 degree angle is absorbed and the rest is reflected). Of course, the emissivity for the ‘reflective coating’ may be in the range of 0.10 to 0.20, or 0.05 to 0.25. ‘Absorptive coating’ means that the coating has an emissivity of 0.90 or greater (i.e. 90% of energy from radiation received by the coating at a 90 degree angle is absorbed and the rest is reflected). Of course, the emissivity for the ‘absorptive coating’ may be in the range of 0.85 to 0.95, or 0.80 to 0.95.

In some examples, the coating provided on the at least one portion 302 may include one of a calcium silicate, EP30 insulating resin, aerogel sprays (for example, microspheres of aerogel), ceramic sprays (for example, microbeads of ceramic material), ultra-black paint coatings, white paint coatings, vanta-black paint coatings and/or phase change sheets/coating (for example, sheets/coatings that use microbeads of wax/silica/silicone that change state to absorb thermal energy).

Advantageously, the article 300 having at least one portion 302 that is configured to reflect and/or absorb thermal energy allows for thermal energy to be retained close to the article 300 or maintained, for example in the oven of the apparatus 100.

FIG. 4 shows another apparatus 400 for heating aerosol-generating material. The apparatus 400 may include a base 403 configured to receive aerosol-generating material. The base 403 may act as a heater to heat the aerosol-generating material. For example, a planar consumable (not shown) having aerosol-generating material provided thereon may be inserted into the apparatus 400 on to the base 403.

The apparatus 400 may also include a lid 401 that is hinged with the base 403. The lid 401 is configured to move in the direction D′ around the hinge. As shown in FIG. 4, the lid 401 is in an open position. The inner surface of the lid 401 (e.g. the surface closest to the base 403) is configured to absorb and/or reflect thermal energy. For example, the inner surface of the lid 401 may be provided with a coating 402 thereon. The coating 402 may be a reflective coating or an absorptive coating. ‘Reflective coating’ means that the coating has an emissivity of 0.15 or less (i.e. 15% of energy from radiation received by the coating at a 90 degree angle is absorbed and the rest is reflected). Of course, the emissivity for the ‘reflective coating’ may be in the range of 0.10 to 0.20, or 0.05 to 0.25. ‘Absorptive coating’ means that the coating has an emissivity of 0.90 or greater (i.e. 90% of energy from radiation received by the coating at a 90 degree angle is absorbed and the rest is reflected). Of course, the emissivity for the ‘absorptive coating’ may be in the range of 0.85 to 0.95, or 0.80 to 0.95.

In some examples, the coating provided on the at least one portion 302 may include one of a calcium silicate, EP30 insulating resin, aerogel sprays (for example, microspheres of aerogel), ceramic sprays (for example, microbeads of ceramic material), ultra-black paint coatings, white paint coatings, vanta-black paint coatings and/or phase change sheets/coating (for example, sheets/coatings that use microbeads of wax/silica/silicone that change state to absorb thermal energy).

Advantageously, the lid 401 having an inner surface that is configured to reflect and/or absorb thermal energy may then maintain the heat within a space between the lid 401 and the consumable (not shown). Therefore, the efficiency of the apparatus is improved.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device comprising:
a first wall defining a receiving section;
a second wall surrounding the first wall;
wherein the device is configured to heat the receiving section;
wherein at least one of the first wall and second wall is configured to reflect and/or absorb thermal energy.

2. The aerosol provision device of claim 1, wherein the at least one of the first wall and second wall has a coating applied thereto.

3. The aerosol provision device of claim 2, wherein the coating is one of a reflective coating or an absorptive coating.

4. The aerosol provision device of claim 3, wherein the reflective coating has an emissivity of at most 0.15 and wherein the absorptive coating has an emissivity of at least 0.90.

5. The aerosol provision device of claim 3, wherein the first wall has the absorptive coating.

6. The aerosol provision device of claim 3, wherein the second wall has the reflective coating configured to reflect heat towards the first wall.

7. The aerosol providing device of claim 3, wherein the reflective coating and/or absorptive coating comprises at least one of a calcium silicate, EP30 insulating resin, an aerogel spray, a ceramic spray, an ultra-black paint coating, a white paint coating, a vanta-black paint coating and/or a phase change sheet/coating.

8. The aerosol provision device of claim 1, wherein the first wall is a wall of a susceptor.

9. The aerosol provision device of claim 1, wherein the second wall is a wall of an insulating member.

10. An article for use in the aerosol provision device as claimed in claim 1, wherein the article comprises:
a support comprising a surface comprising at least one portion configured to absorb and/or reflect thermal energy; and
aerosol-generating material provided on the at least one portion.

11. The article of claim 10, wherein the at least one portion includes a coating.

12. The article of claim 11, wherein the coating is one of a reflective coating or an absorptive coating.

13. The article of claim 12, wherein the reflective coating has an emissivity of at most 0.15 and wherein the absorptive coating has an emissivity of at least 0.9.

14. The article of claim 12, wherein the reflective coating and/or absorptive coating comprises at least one of a calcium silicate, EP30 insulating resin, an aerogel spray, a ceramic spray, an ultra-black paint coating, a white paint coating, a vanta-black paint coating and/or a phase change sheet/coating.

15. An aerosol provision device comprising;
a base;
a lid connected to the base such that the lid can pivot around a hinge, wherein the lid is configured to absorb and/or reflect thermal energy.

16. The aerosol provision device of claim 15, wherein the base is configured to receive aerosol-generating material.

17. The aerosol provision device of claim 16, wherein the base is configured to heat the aerosol-generating material.

18. The aerosol provision device of claim 15, wherein the lid includes a coating.

19. The aerosol provision device of claim 18, wherein the coating is one of a reflective coating or an absorptive coating.

20. The article of claim 19, wherein the reflective coating has an emissivity of at most 0.15 and wherein the absorptive coating has an emissivity of at least 0.90.

21. The article of claim 19, wherein the reflective coating and/or absorptive coating comprises at least one of a calcium silicate, EP30 insulating resin, an aerogel spray, a ceramic spray, an ultra-black paint coating, a white paint coating, a vanta-black paint coating and/or a phase change sheet/coating.
